(19) United States
(12) Patent Application Publication
(10) Pub. No.: US 2004/0263959 A1
(43) Pub. Date: Dec. 30, 2004

(54) Scanning beam optical imaging system for macroscopic imaging of an object

(76) Inventors: Arthur E. Dixon, Waterloo (CA); Savvas Damaskinos, Waterloo (CA)

Correspondence Address: DARYL W SCHNURR, MILLER THOMSON LLP, PO BOX 578, SUITE 700, 22 FREDERICK STREET, KITCHENER, ON, N2G 4A2, CA

(21) Appl. No.: 10/608,217

(22) Filed: Jun. 30, 2003

(51) Int. Cl. G02B 21/06

(52) U.S. Cl. 359/385

(57) ABSTRACT

A new high resolution confocal and non-confocal scanning laser macroscope is disclosed which images macroscopic specimens in reflected light, transmitted light, fluorescence, photoluminescence and multi-photon fluorescence. The optical arrangement of a scanning laser macroscope has been altered to include a liquid-immersion laser scan lens, providing higher numerical aperture and higher resolution; and higher intensity at the focal spot, which makes the macroscope particularly well suited for multiphoton imaging. Several applications of the imaging system are described. A liquid-immersion laser scan lens with spring-loaded bottom element and method for containing the immersion liquid are also disclosed.

### BACKGROUND OF THE INVENTION

1. Field of Invention

This invention relates to a scanning beam optical imaging system for macroscopic imaging of an object. More particularly, this invention relates to the fields of confocal and non-confocal imaging of microscopic and macroscopic objects with emphasis on scanning-beam imaging systems using reflected light, transmitted light, fluorescence and photoluminescence as contrast mechanisms, including multi-photon fluorescence imaging and spectrally-resolved fluorescence imaging.

2. Description of the Prior Art

For confocal and non-confocal imaging, the most important characteristics of a laser scan lens are its external entrance pupil (at which position a scanner can be placed), and its wide field of view. In contrast, a microscope objective has an entrance pupil positioned at the entrance to or inside the lens barrel, and intermediate optics must be used to translate the scanning beam from the scanner to the position of the entrance pupil. In addition, laser scan lenses used in imaging are usually colour corrected, telecentric, and f*theta objectives. The field of view of a laser scan lens is approximately twenty times the field of view of a microscope objective having the same numerical aperture.

When a confocal scanning laser microscope is used to image large specimens (larger than about 1 mm×1 mm in size), a common technique is to make several small images and stitch them together using software. The number of small images that have to be stitched together depends on the magnification of the microscope objective. For example, with a 10× objective (NA=0.3), the field of view is approximately 0.8 mm. In order to image a 5 mm×5 mm specimen, it would be necessary to collect 7×7=49 small images, and stitch them together in software (with a small overlap on all four sides of the inner images in the montage). This is very time consuming, and considerable care must be taken to match up the sides of the small images. By comparison, a scanning laser macroscope (as described in U.S. Pat. No. 5,760,951), using a telecentric f-theta laser scan lens instead of a microscope objective, can image the entire specimen in a single scan, with considerable saving in time. For example, one confocal scanning laser macroscope that uses a laser scan lens with NA=0.3 has a field of view of 2.2 cm, and when set up in a scanning-beam/scanning-stage configuration, can image the entire surface of a microscope slide in a single scan.

When higher resolution is required, the fields of view of both instruments (microscope and macroscope) are reduced. With a 40× objective (NA approximately 0.6), the field of view of the microscope is reduced to approximately 0.2 mm. A comparable macroscope, with a laser scan lens with NA=0.5, has a field of view of 1 cm. In this case, using the microscope, the same 5 mm×5 mm specimen would require more than 625 small images to be stitched together, while the macroscope images the entire specimen in a single scan.

FIG. 1 shows one embodiment of a prior art confocal scanning laser macroscope. In this embodiment, the incoming laser beam 101 from laser 100 passes through a spatial filter and beam expander (comprised of lens 102, pinhole 104 and lens 106), and is expanded to match the diameter of the entrance pupil 112 of laser scan lens 118 (note—entrance pupil 112 as indicated on the figure simply indicates the position of the entrance pupil. A real stop is not usually placed at this position). Scanning mirrors 110 and 116 deflect the beam in a raster scan, and rotate about axes that are perpendicular to each other. These mirrors are placed close together, on either side of the entrance pupil of the laser scan lens. Laser scan lens 118 focuses the beam to a spot on the sample 120, and reflected light is collected by laser scan lens 118, descanned by scanning mirrors 116 and 110, and partially reflected by beamsplitter 108 into a confocal detection arm comprised of lens 128, pinhole 130 and detector 132. Light reflected back from the focused spot on the sample passes through pinhole 130 and is detected, but light from any other point in the sample runs into the edges of the pinhole and is not detected. The scan mirrors are computer-controlled to raster the focused spot across the sample. A computer, represented by computer screen 134, is connected to the detector 132 to store and display a signal from detector 132. The computer provides means for displaying the signal from the detector. This confocal macroscope has properties similar to those of a confocal scanning laser microscope, except that the field of view of the microscope is much smaller.

Several other embodiments of the macroscope are presently in use. These include instruments for fluorescence and photoluminescence (including spectrally-resolved) imaging (several other contrast mechanisms are also possible), instruments in which a stage scan in one direction is combined with a beam scan in the perpendicular direction, non-confocal versions, and other embodiments. The combination of a scanning laser macroscope with a scanning laser microscope to provide an imaging system with a wide field of view and the high resolution capability of a microscope was described in U.S. Pat. No. 5,532,873.

The prior-art macroscopes described herein and in the literature have some limitations. The optical resolution can be increased by increasing the numerical aperture of the laser scan lens, but with decreased field of view. For example, we use a scan lens with a numerical aperture of 0.3 and a field of view of 2.2 cm, but when the numerical aperture was increased to 0.5 in a second lens design, the field of view was reduced to 1.0 cm.

### SUMMARY OF INVENTION

It is an object of this invention to provide a high resolution liquid-immersion laser scan lens, and a method for using such a lens in a scanning laser macroscope.

It is a further object of this invention to provide a liquid-immersion laser scan lens with spring-loaded bottom elements to prevent damage on contact between the lens and the sample.

It is a further object of this invention to provide a high resolution confocal or non-confocal scanning beam optical imaging system for macroscopic specimens using a liquid-immersion laser scan lens. (note—can use other light sources, scanning-beam/scanning-stage configuration, any index-matching fluid can be used, etc.)

It is a further object of this invention to provide a high resolution inverted confocal or non-confocal scanning beam optical imaging system for macroscopic specimens using a liquid-immersion laser scan lens.

It is a further object of this invention to provide a transmission scanning-beam optical imaging system using a liquid-immersion laser scan lens.

It is a further object of this invention to provide a real-time confocal scanning beam optical imaging system using a liquid-immersion laser scan lens in combination with a Nipkow Disk.

It is a further object of this invention to provide a method of scanning macroscopic specimens that uses a liquid-immersion laser scan lens to provide increased resolution and laser light intensity at the focal point.

It is a further object of this invention to provide a confocal or non-confocal scanning instrument using a water-immersion laser scan lens for in-vivo imaging, and for imaging excised tissue.

It is a further object of this invention to provide a confocal or non-confocal scanning imaging system using an oil-immersion laser scan lens for imaging tissue specimens mounted under cover glass.

It is a further object of this invention to provide a scanning beam optical imaging system for imaging arrays of tissue specimens, and arrays of cell specimens.

It is a further object of this invention to provide a scanning beam optical instrument for multi-photon fluorescence imaging.

It is a further object of this invention to provide a high resolution fluorescence imaging system for microarrays with small probe spots (e.g. Affymetrix GeneChips®, microarrays from Nimblegen, Clondiag, Illumina, etc., protein arrays and arrays of biomolecules, cells, etc.).

It is a further object of this invention to provide an apparatus and method for performing image-guided microsurgery using multi-photon absorption for cutting (excising or resecting) tissue.

It is a further object of this invention to provide an apparatus and method for image-guided photodynamic therapy.

A scanning beam optical imaging system for macroscopic imaging of an object has an illumination source producing a light beam directed upon an optical path toward the object. A scan lens has an external entrance pupil for focusing the light beam to a defraction limited configuration in a prescribed object plane. A scanner is used to scan the light beam to move the defraction limited configuration to a pre-determined scan pattern on the object plane. The scan lens is a liquid immersion scan lens with an immersion liquid filling a space between the scan lens and the object. A detector is located to receive light from the object plane and there is a display to produce a signal from the detector.

A liquid immersion scan lens has a scan lens with an external entrance pupil for focusing light on an object in a prescribed object plane. An immersion liquid fills a space between the scan lens and the object.

A method of constructing a scanning beam optical imaging system for macroscopic imaging of an object, said system having an illumination source producing a light beam directed upon an optical path toward said object, a scanner for scanning the light beam, a detector located to receive light from said object plane a display to produce a signal from said detector, said method comprising inserting a scan lens having an external entrance pupil for focusing said light beam to a defraction-limited configuration in a prescribed object plane and scanning said light beam using said scanner to move the defraction-limited spot in a predetermined scan pattern on said object plane.

A method of constructing a multi-photon or two photon scanning beam optical imaging system for a macroscopic object, said system having a short pulse labor source producing a light beam directed along an optical path toward said object, a scanner for scanning said light beam, a detector located to receive light from said object plane and a display to produce a signal from said detector, said method comprising inserting a liquid-immersion scan lens for focusing said light beam to a defraction-limited configuration in a prescribed object plane without forming an image plane between said scan lens and said object plane and scanning said light beam using the scanner to remove said defraction-limited configuration in a predetermined scan pattern on said object plane.

### BRIEF DESCRIPTION OF THE DRAWINGS

FIG. 1 shows a prior art confocal scanning-beam optical macroscope;

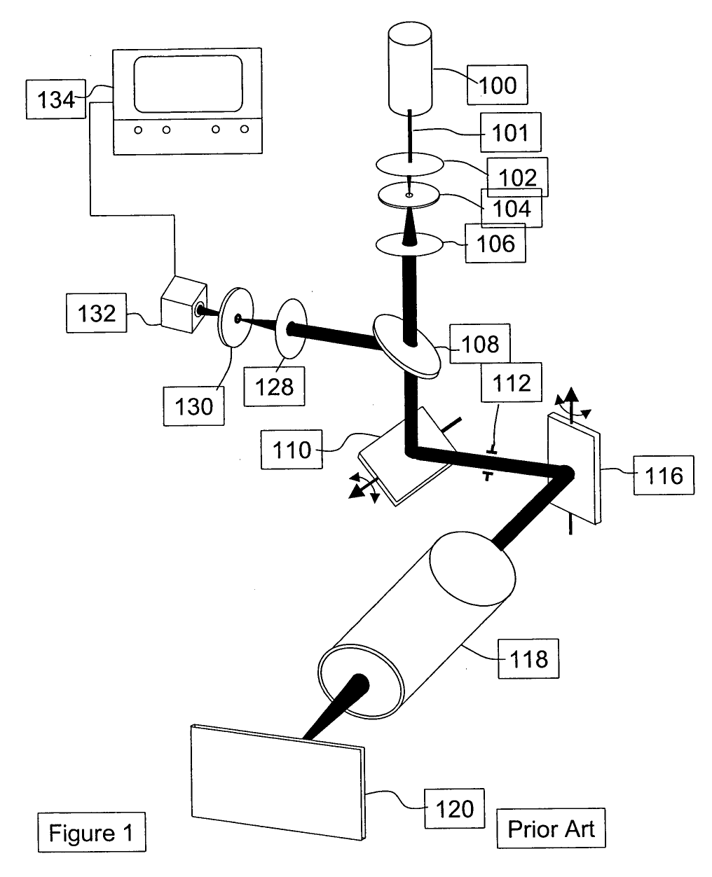

FIG. 2 shows a fluid-immersion laser scan lens;

FIG. 3a shows a multi-element immersion laser scan lens with a spring-loaded bottom element;

FIG. 3b shows a multi-element immersion scan lens in use with an object that has no cover slip;

FIG. 4a shows a scanning-beam/scanning-stage confocal macroscope using a liquid immersion scan lens;

FIG. 4b shows a scanning-beam scanning-stage confocal macroscope with a non-confocal transmission detector;

FIG. 5 shows a two-photon (or multiphoton) scanning laser macroscope using a liquid immersion laser scan lens;

FIG. 6 shows a Nipkow-Disk macroscope using a liquid-immersion laser scan lens;

### DESCRIPTION OF A PREFERRED EMBODIMENT

Assuming diffraction-limited performance in a laser focusing lens (whether it is a simple molded lens with one or two aspheric surfaces, a more complicated lens like a microscope objective, or a laser scan lens), the size of the focused spot depends on the laser wavelength and the numerical aperture (NA) of the lens. The Full Width Half Maximum (FWHM) of the illumination Point Spread Function of the focused laser spot is given by¹ (for unpolarized light):

Wₓ=W_{y}=0.51λ/(n sin α) (1)

and W_{z}=0.44λ/(n sin²(α/2)) (2)

where n is the index of refraction of the immersion medium, and α is the semi-aperture angle of the scan lens (NA=n sinα). The z direction is the axial direction. These formulas are changed only slightly for polarized light.

When the word “object” is used in the present application, it includes any subject that is used with an optical imaging system or with a liquid immersion scan lens including, without limiting the generality of the foregoing, a sample, specimen, body or subject including living organisms or parts of a body or subject. The liquid immersion scan lens and the optical imaging system of the present invention can be used for in vivo applications.

Many applications of scanning imaging are improved when the laser energy is concentrated into a smaller focal volume, and by the increased resolution resulting from a smaller focus spot. In addition to improved lateral resolution, a smaller depth of focus improves confocal image-slicing ability, and reduces the amount of out-of-focus fluorescence that is detected in a fluorescence imager. This is especially important for imaging genetic microarrays that have a source of background fluorescence, e.g. microarrays on glass microscope slides, where the weak fluorescence emission from the glass slide itself often sets the minimum level of fluorescence that can be detected from a probe spot, and for microarrays that are read in the presence of a liquid that contains some residual fluorescence (like Affymetrix GeneChips, as one example).

Other applications where performance is improved by concentrating the laser energy into a smaller focused volume include multiphoton (including two-photon) fluorescence imaging and multi-photon absorption for cutting, as in laser surgery. In both of these applications laser absorption is nonlinear, and is almost entirely limited to the high-intensity region at the focal point of the strongly-focused excitation laser.² In multi-photon fluorescence, excitation of background fluorescence is avoided, no confocal pinhole is required, and photobleaching is limited to the in-focus volume. When multi-photon absorption is used for cutting, as in laser surgery, tissue damage is confined to the focal spot volume where absorption occurs.

Another application in which a small focus volume is important is photodynamic therapy. In this application the optical excitation of the photodynamic therapy drug should be confined as much as possible to the area of interest, in order to reduce damage to surrounding tissue.

The present invention is a high-resolution confocal and non-confocal scanning laser macroscope using a liquid-immersion laser scan lens with a large Numerical Aperture (NA).

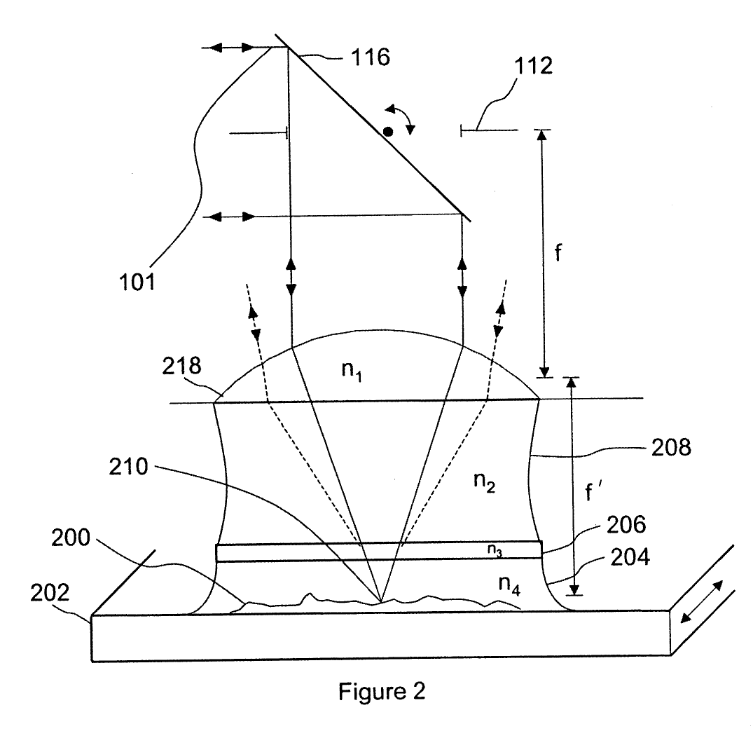

A simple liquid-immersion laser scan lens is shown in FIG. 2. Expanded laser beam 101 is reflected by scanning mirror 116 towards laser scan lens 218. Note that in this figure scanning mirror 116 has been placed at the entrance pupil position 112 of the laser scan lens; the low-speed scan is accomplished by moving the specimen on a scanning stage (this is a scanning-beam/scanning-stage configuration). Other scan mechanisms can be used. Laser scan lens 218 is shown as a plano-convex lens for simplicity, with the entrance pupil position 112 a distance f above the lens. The incoming laser beam is focused by laser scan lens 118 onto specimen 200 mounted on microscope slide 202. Specimen 200 is shown inside a mounting medium 204 below a cover glass 206. The space between the cover glass and the bottom surface of the scan lens 218 is filled with immersion fluid 208. In this case the immersion fluid was chosen to have the same (or nearly the same) index of refraction as the glass in the lens, and the cover glass and mounting medium. When these indexes of refraction are the same, the converging cone of light is not refracted when passing through the interfaces between the bottom of the scan lens and the immersion fluid, the immersion fluid and the cover glass, and the cover glass and the mounting medium. This means that the bottom surface of the scan lens has no focusing affect on the light passing through it and it may be given any convenient shape. Light reflected from the specimen at the focal point (or fluorescence emitted from the specimen at this position) is collected by the scan lens, following the same cone but in the opposite direction, is descanned by scanning mirror 116, and passes back toward the detector (not shown). If no immersion fluid 208 were used, in order to achieve the same focal spot size at the specimen, the light traveling toward the specimen would have to follow a wider cone shown by the dashed lines, and the focal length of the scan lens in air would have to be reduced as well as having to increase the diameter of the lens. The use of an immersion fluid has increased the numerical aperture of the lens and thus has increased the resolution achievable with a scanning imaging system, as well as increasing the laser energy density at the focal spot volume.

Immersion fluids are chosen to fit the application, and the scan lens is designed to achieve best performance with the chosen fluid. For example, oil is often chosen for imaging biological specimens under a cover glass (as in FIG. 2), since the index of refraction of the oil can closely match the index of refraction of the bottom lens element and the cover glass. For biological specimens that are not mounted under a cover glass, including in-vivo applications, the immersion fluid most often chosen is water, and the lens is designed accordingly. Because water has a smaller index of refraction than oil, the increase in NA in a water immersion scan lens is smaller than in an oil-immersion lens, when compared to a lens used in air (an “air-immersion” lens). Other immersion fluids are sometimes used, including glycerine and mineral and vegetable oils.

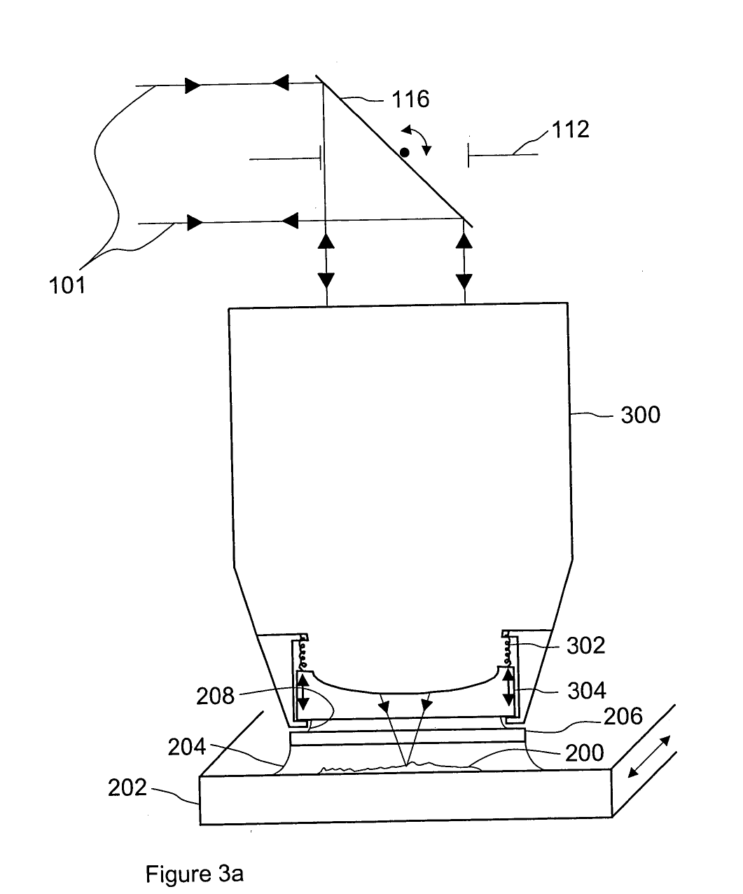

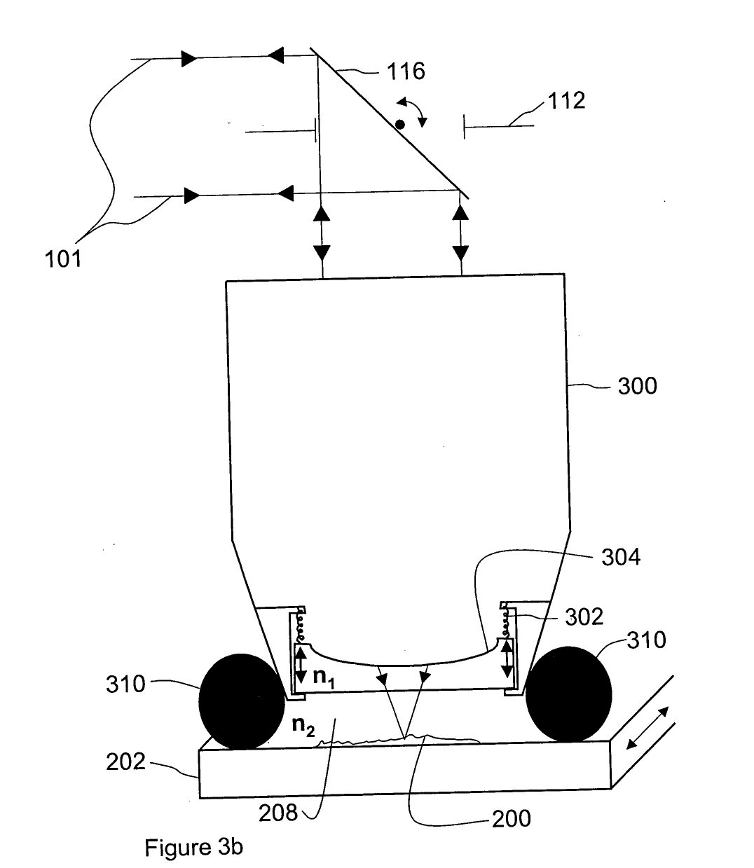

A more practical fluid-immersion scan lens arrangement is shown in FIG. 3a. In this figure the simple scan lens 218 of FIG. 2 has been replaced by a multi-element scan lens 300. Only the bottom lens element 304 is shown, and it is spring loaded by springs 302 such that this lens element will not be damaged if it comes into contact with the specimen or cover glass. An alternative to using spring-loaded lens elements is to use a spring-loaded sample carrier. Scan lens 300 has a short working distance (usually a few millimeters or less) resulting in only a thin layer of immersion fluid 208.

FIG. 3b shows a situation where the specimen 200 is not mounted under a cover glass. In this arrangement an immersion fluid 208 is chosen such that n₂ is approximately equal to n₁, and the entire volume between the specimen and the bottom lens element 304 is filled with immersion fluid. Because of the large volume to be filled with fluid, an O-ring 310 has been placed around the barrel of the laser scan lens, in contact with the microscope slide 202, to act as a dam to hold the immersion fluid in place. Any side wall can be used to retain the immersion liquid as long as the side wall has a sealing relationship with the scan lens. The side wall may have a substantial sealing relationship with the object. For example, with in vivo imaging, an insignificant amount of immersion liquid might escape between the side wall and that part of the body with which the liquid immersion scan lens is being used. This arrangement will also be of use for in-vivo imaging, where it is necessary to contain the immersion fluid between the laser scan lens and the tissue being imaged. It will also be important in inverted macroscopes, where the specimen is viewed from beneath, often through a transparent sample support (like a glass slide or a container with a transparent bottom).

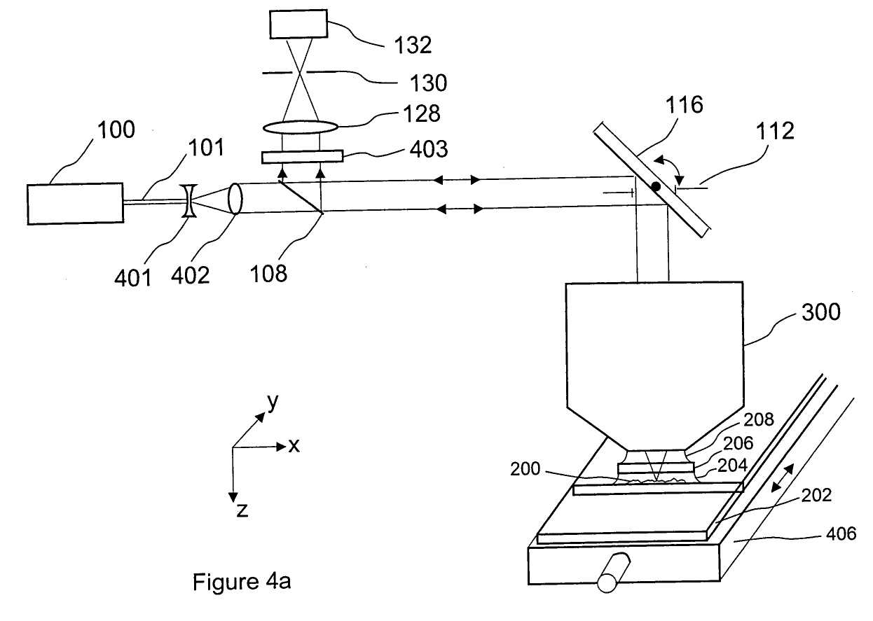

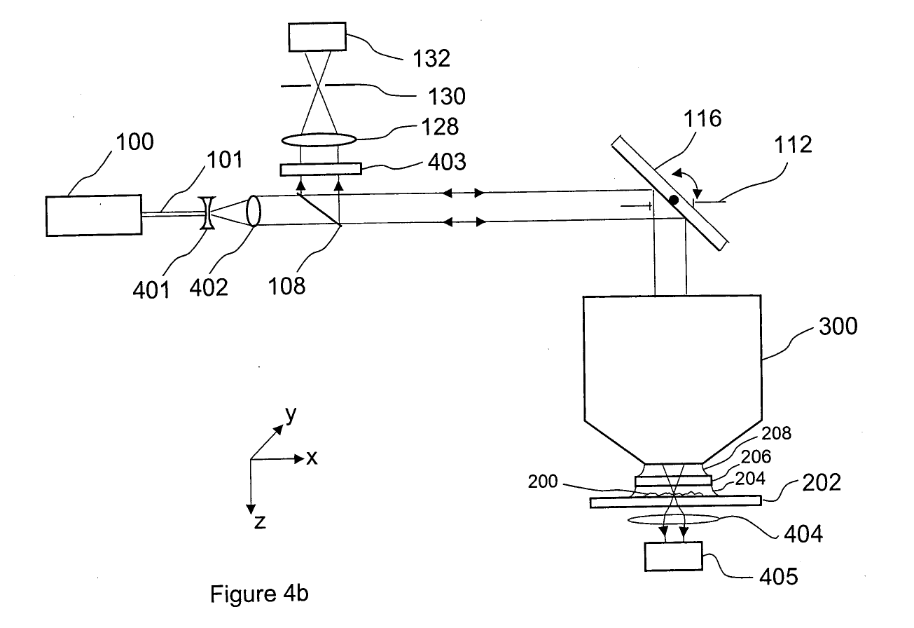

The complete optical diagram of a confocal scanning laser macroscope using a fluid-immersion laser scan lens is shown in FIG. 4a. Laser beam 101 from laser 100 is expanded by a beam expander comprised of lenses 401 and 402 to fill the entrance pupil 112 of the laser scan lens 300, passes through beamsplitter 108, and is reflected by scanning mirror 116 toward scan lens 300. Note that, as before, a real stop is not required at the entrance pupil position—112 simply indicates the size and position of the external entrance pupil of scan lens 300. Scan lens 300 focuses the incoming beam onto specimen 200, after passing through immersion fluid 208, cover glass 206 and mounting medium 204. Specimen 200 is mounted on the surface of microscope slide 202. Light emitted from, or reflected by, specimen 200 at the focal point is collected by scan lens 300, descanned by scanning mirror 116, and is reflected by beamsplitter 108 into a detection arm comprised of filter 403, detector lens 128, pinhole 130, and detector 132. For fluorescence imaging, beamsplitter 108 is usually a dichroic beamsplitter, and filter 403 is a laser rejection filter. Beamsplitter and filter combinations depend on the application. In some applications (e.g. reflected light), no filter 403 is required. A non-confocal version of the macroscope requires no pinhole, and detector lens 128 can be replaced by a condenser lens (or no lens at all if detector 132 has an active area that is as large as the incoming light beam).

The macroscope shown in FIG. 4a has a scanning-beam/scanning-stage configuration. Beam scanner 116 moves the focus spot in the x-direction, while scanning stage 406 moves the specimen in the y-direction. Other scan configurations are also possible, including using a pair of scanning mirrors that are equidistant from and on opposite sides of the entrance pupil position, a dual axis scanning mirror, rotating polygon scanners, and many more.

FIG. 4b illustrates the addition of a non-confocal transmission detector to a macroscope that uses an immersion lens. Light passing through specimen 200 passes through microscope slide 202, is collected by condenser lens 404 and detected by transmission detector 406. If condenser lens 404 is placed a distance equal to its focal length below the macroscope's focal plane in specimen 200, and the active area of detector 406 is placed one focal length below lens 404, then motion of the incoming beam on the active area is reduced (especially if scan lens 300 is telecentric, as is usually the case). We have found that a fresnel lens with short focal length and large diameter works well as collection lens 404.

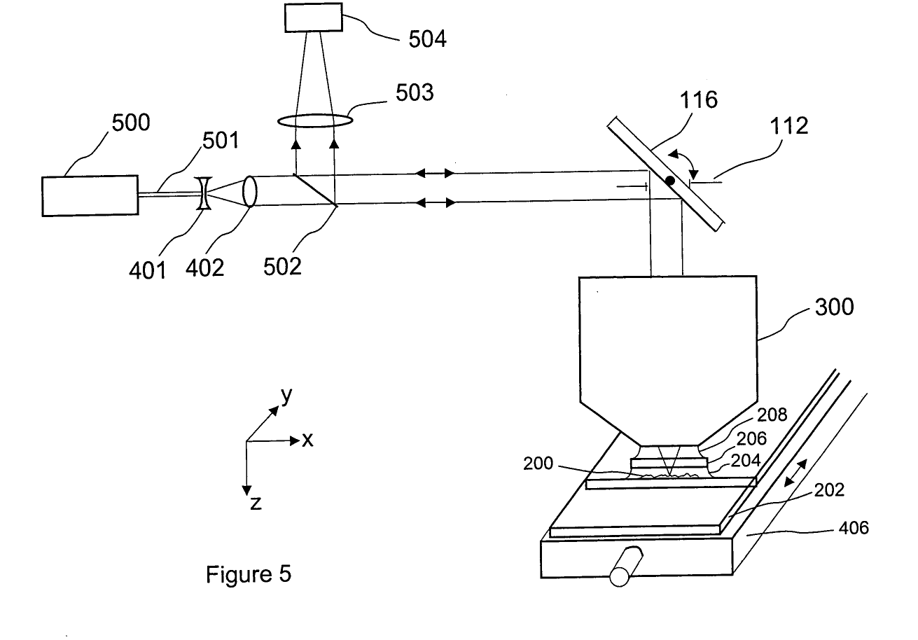

FIG. 5 illustrates a two-photon (or multiphoton) macroscope. Laser beam 501 from Short Pulse Laser 500 (a picosecond or femtosecond or other short pulse laser) is expanded to fill the entrance pupil of laser scan lens 300 by a beam expander comprised of lenses 401 and 402, passes through dichroic beamsplitter 502, is scanned by scanner 116, and focused by liquid immersion scan lens 300 to a focal spot. Two-photon (or multiphoton) fluorescence from the specimen at the focus volume is collected by scan lens 300, descanned by scanner 116, and is reflected by Dichroic beamsplitter 502, and passes through condenser lens 503 into detector 504. Note that no confocal pinhole is required since the two-photon fluorescence is excited only inside the focus volume of the short pulse laser. The increased NA of the immersion lens (as compared to a non-immersion lens) increases the intensity of the light at the focus, thus improving two-photon (or multiphoton) absorption. One particularly useful embodiment for use in surgical applications, or for in-vivo imaging, is a macroscope with this design in which the scan lens 300 is designed to work with water as an immersion fluid.

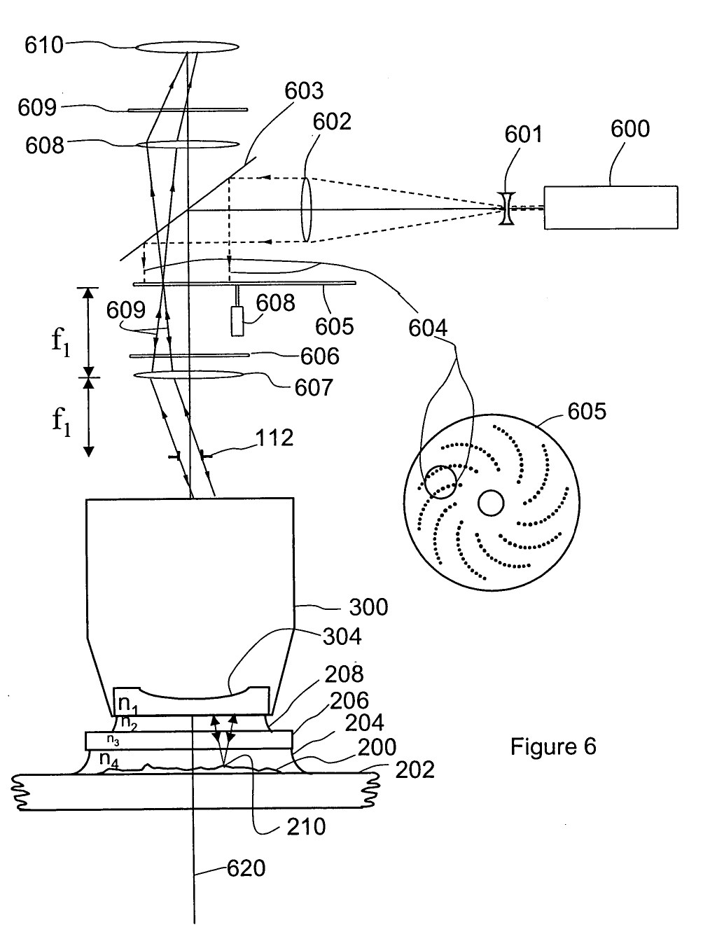

A Nipkow Disk macroscope that incorporates a liquid-immersion laser scan lens is shown in FIG. 6. A prior-art Nipkow Disk macroscope was described in U.S. Pat. No. 5,737,121. A liquid immersion laser scan lens provides a higher Numerical Aperture, and thus a smaller focal spot size and higher resolution for the Nipkow Disk macroscope, just as for the systems that use a single scanning beam described earlier in this patent. In FIG. 6, polarized light from laser 600 (or other light source) passes through a beam expanding telescope comprised of lens 601 and lens 602, and is partially reflected by beamsplitter 603 onto Nipkow Disk 605, illuminating area 604 on the disk. The disk is rotated by motor 608. Light 609 from one of the illuminated pinholes (shown as solid lines with arrows) expands through a quarter-wave plate 606 and enters focusing lens 607 of focal length f₁ placed a distance f₁ below the Nipkow Disk. A liquid-immersion telecentric scan lens 300 is placed below focusing lens 607 such that the position of its entrance pupil 112 is a distance f₁ from focusing lens 607, and that the illuminated area 604 on Nipkow Disk 605, focusing lens 607, and liquid-immersion telecentric laser scan lens 300 are coaxial with each other and with the optic axis 620 of the macroscope. (Note that entrance pupil 112 as indicated on the figure simply indicates the position of the entrance pupil. A real stop is not usually placed at this position.) Focusing lens 607 changes the light expanding from the pinhole into a parallel beam that crosses the optic axis at the position of the entrance pupil of liquid-immersion telecentric scan lens 300. The telecentric scan lens focuses the light to a diffraction-limited spot 210 on specimen 200 which is mounted on microscope slide 202 (or other specimen holder). Specimen 200 is shown inside a mounting medium 204 below a cover glass 206. The space between the cover glass and the surface of the bottom element 304 of scan lens 300 is filled with immersion fluid 208. In this case the immersion fluid was chosen to have the same (or nearly the same) index of refraction (n₂) as the glass in the lens (n₁), the cover glass (n₃) and mounting medium (n₄). Light reflected from that spot on the specimen is collected by the scan lens, passes back through focusing lens 607 and quarter-wave plate 606, and is brought to a focus on the same pinhole in the Nipkow Disk. After passing through the pinhole, it is partially transmitted by beamsplitter 603, and is focused by lens 608 onto a real image plane (not shown) where the image can be detected with a detector array, or it can be viewed with eyepiece 610. At the same time, light from the other pinholes in the illuminated area of the disk also passes through the system, and is focused to points on the real image plane. When viewed through the eyepiece, the eye averages the many moving spots in the image plane, to form a real-time image. Polarized light source 600, quarter-wave plate 606 and analyzer 609 are used in combination to reduce the amount of which reaches the detector after being reflected or scattered from the Nipkow Disk. Light returning from the specimen has passed through the quarter-wave plate twice, such that its polarization has been rotated to a direction at right angles to the polarization of the incoming light, and the analyzer is then rotated to reject light with the same polarization as the incoming light, but to pass light polarized at right angles to that of the incoming light. Note that if specimen 200 is in air, then the entire volume between the bottom lens element 304 of liquid immersion scan lens 300 and the surface of the specimen 200 must be filled with immersion fluid, and in that situation a dam 310 like that shown in FIG. 3b will probably be required to contain the fluid.

All of the embodiments shown in the figures are based on an infinity-corrected optical design, however non-infinity corrected versions are also possible. Non-telecentric scan lenses can also be used. The light source shown is a laser however other light sources can also be used, including arc lamps and light-emitting diodes. Reflecting optics can also be used.

The term scan lens (or laser scan lens), as used in this document, describes a lens that is normally used for focusing a parallel beam of light to a small spot that scans across the focal plane. The incoming parallel beam is directed by a scanner placed at the position of the entrance pupil of the scan lens. Such a lens has a combination of wide angular field, a flat image plane, and an external entrance pupil (at which position a scanning mirror or other scanner is often placed). Although many laser scan lenses are monochromatic, color-corrected scan lenses are also available, and are usually used in the macroscope. Many scan lenses include f*theta correction and many are telecentric.

Several embodiments of a novel high-resolution scanning optical macroscope for imaging microscopic and macroscopic specimens have been disclosed.

We claim:

1. A scanning beam optical imaging system for macroscopic imaging of an object, said system comprising:
a) an illumination source producing a light beam directed upon an optical path toward said object;
b) a scan lens having an external entrance pupil, for focusing said light beam to a diffraction-limited configuration in a prescribed object plane;
c) a scanner for scanning said light beam to move said diffraction-limited configuration in a pre-determined scan pattern on said object plane;
d) said scan lens being a liquid immersion scan lens with an immersion liquid filling a space between said scan lens and said object;
e) a detector located to receive light from said object plane and a display to produce a signal from said detector.

2. An imaging system as claimed in claim 1 when said system is a confocal imaging system and there is a detection arm located between said object and said detector, said detection arm receiving light from said diffraction-limited configuration in said object plane, said detection arm having a pinhole and a focusing lens to obtain a focal point for confocal detection of said light returning from said object, said detector being located behind said pinhole, there being a beamsplitter located between said detection arm and said object, said beamsplitter directing light returning from said object into said detection arm.

3. An imaging system as claimed in claim 1 wherein said system is a non-confocal imaging system and there is a detection arm located between said detector and said object, said detection arm receiving light from said diffraction-limited configuration in said object plane.

4. An imaging system as claimed in claim 3 wherein said detection arm having a first condenser lens therein, said detector being located behind said first condenser lens.

5. An imaging system as claimed in claim 4 wherein there is a beamsplitter located between said object and said detection arm, said beamsplitter directing light returning from said object into said detection arm.

6. An imaging system as claimed in claim 5 wherein said beamsplitter is connected to de-scan said beam.

7. An imaging system as claimed in any one of claims 1, 2, or 4 wherein the scan lens is a telecentric f*theta liquid-immersion scan lens.

8. An imaging system as claimed in any one of claims 1, 2, and 4 wherein said detector is a spectrally-resolved detector.

9. An imaging system as claimed in any one of claims 1, 2, or 4 wherein there are means for supporting said object to be observed and measured.

10. An imaging system as claimed in any one of claims 1, 2, or 4 including a second condenser lens and a transmission detector placed on an opposite side of said object, said condenser lens and said transmission detector being coaxial with said scan lens, whereby light transmitted through said specimen is detected.

11. An imaging system as claimed in any one of claims 1, 2, or 4 wherein said illumination source is a laser.

12. An imaging system as claimed in any one of claims 1, 3, or 4 wherein a laser rejection filter is placed in front of said detector, said imaging system being a multiphoton or two photon imaging system wherein said illumination source is a short pulse laser to excite multiphoton or two photon fluorescence respectively in said specimen, said laser rejection filter filtering out a signal from said laser, said immersion liquid increasing a numerical aperture of said liquid-immersion scan lens, thereby increasing an intensity of light at a focal point of said lens and improving multiphoton or two photon absorption respectively.

13. An imaging system as claimed in any one of claims 1, 2 or 4 wherein there is a sidewall surrounding said scan lens, said sidewall extending between said scan lens and said object, said sidewall having a substantial sealing relationship with said scan lens and said object to retain said immersion liquid of said liquid-immersion scan lens between said scan lens and said object.

14. An imaging system as claimed in claim 1, said imaging system being a real-time imaging system, there being a rotating Nipkow disk located between said illumination source and said object, said Nipkow disk producing a plurality of expanding beams moving toward said object, there being a focusing lens rigidly mounted a distance equal to a focal length of said focusing lens above an entrance pupil of said scan lens, said focusing lens also being a distance equal to a focal length of said focusing lens below said Nipkow disk, said focusing lens and said scan lens in combination focusing said expanding beams to diffraction-limited configurations in a prescribed object plane, said light from said object plane returning through said Nipkow disk with means for focusing said light returning through said Nipkow disk to produce a real image, said detector detecting said image.

15. An imaging system as claimed in claim 14 wherein said focal plane array is a charged coupled array.

16. An imaging system as claimed in claim 14 wherein said imaging system is a real-time scanning optical macroscope.

17. An imaging system as claimed in claim 14 wherein said liquid-immersion scan lens is a telecentric f*theta liquid-immersion scan lens.

18. An imaging system as claimed in any one of claims 1, 2, 4 or 14 wherein a part of the scan lens closest to the object is spring mounted.

19. An imaging system as claimed in any one of claims 1, 2, 4 or 14 wherein said diffraction-limited configuration is one of a spot and a line.

20. An imaging system as claimed in any one of claims 1, 2, 4 or 14 wherein said immersion liquid is one of water and oil.

21. A liquid immersion scan lens comprising a scan lens for use with an object, said scan lens having an external entrance pupil for focusing light on said object in a prescribed object plane, said scan lens having an immersion liquid filling a space between said scan lens and said object.

22. A method of constructing a scanning beam optical imaging system for macroscopic imaging of an object, said system having an illumination source producing a light beam directed upon an optical path toward said object, a scanner for scanning the light beam, a detector located to receive light from said object plane a display to produce a signal from said detector, said method comprising inserting a scan lens having an external entrance pupil for focusing said light beam to a defraction-limited configuration in a prescribed object plane and scanning said light beam using said scanner to move the defraction-limited spot in a predetermined scan pattern on said object plane.

23. A method of constructing a multi-photon or two photon scanning beam optical imaging system for a macroscopic object, said system having a short pulse labor source producing a light beam directed along an optical path toward said object, a scanner for scanning said light beam, a detector located to receive light from said object plane and a display to produce a signal from said detector, said method comprising inserting a liquid-immersion scan lens for focusing said light beam to a defraction-limited configuration in a prescribed object plane without forming an image plane between said scan lens and said object plane and scanning said light beam using the scanner to remove said defraction-limited configuration in a predetermined scan pattern on said object plane.
